(19) United States
(12) Patent Application Publication
(10) Pub. No.: US 2015/0379609 A1
(43) Pub. Date: Dec. 31, 2015

(54) GENERATING RECOMMENDATIONS FOR UNFAMILIAR USERS BY UTILIZING SOCIAL SIDE INFORMATION

(71) Applicant: KOBO Incorporated, Toronto (CA)

(72) Inventors: Suvash SEDHAIN, Toronto (CA); Darius BRAZIUNAS, Toronto (CA); Jordan CHRISTENSEN, Toronto (CA)

(21) Appl. No.: 14/320,017

(22) Filed: Jun. 30, 2014

(51) Int. Cl. G06Q 30/06

(52) U.S. Cl. CPC G06Q 30/0631; G06Q 50/01

(57) ABSTRACT

System and method for identifying commodities for recommendation to a target user based on side information that is pertinent to a specific target user and extrinsic to the commodities. Training data is exploited to derive a statistical correlation between users' side information of a plurality of attributes with a plurality of commodities. The training data includes side information of a set of training users and a plurality of commodities towards which the training users have manifested preference. Based on the derived statistical correlation and the target user's side information, a probability distribution representing the target user's tendency to purchase the plurality of commodities can be determined. As a result, a list of commodities can be automatically selected from the plurality of commodities and recommended to the target user.

### TECHNICAL FIELD

The present disclosure relates generally to the field of e-commerce marketing, and, more specifically, to the field of automatic generation of recommendation items.

### BACKGROUND

Presenting customized recommendation lists of relevant products based on individual consumers' shopping and/or behavior patterns has become increasingly important for e-commerce companies in order for them to effectively attract and retain consumers. Many of the recommendation systems have adopted Collaborative Filtering (CF) approaches in which recommendations are made based on a user's manifested preferences, e.g., satisfactory ratings, on particular products. This information can be conveniently collected from the Internet, such as the user's account with a social media network or an on-line store, or the user's browsing history.

In a typical framework adopting a conventional item-to-item CF approach, a recommendation generation process has two primary parts: first, computing similarities between pairs of items (e.g., goods or services) based on user purchase patterns; and second, using those item-to-item similarities to produce a list of items for user-specific recommendation based on user-purchased items. Such a CF approach usually works well once a user has purchased several items.

However, a new or otherwise unfamiliar user usually has no or only a short purchase record, with which to provide inadequate basis for jumpstarting a recommendation in an item-to-time CF approach. This problem is commonly known as a user “cold start” problem, where the conventional CF approaches lack the mechanism to provide effective recommendations.

### SUMMARY OF THE INVENTION

Therefore, it would be advantageous to provide a mechanism to automatically determine recommendations to a cold start user.

Embodiments of the present disclosure employ a computer implemented method of automatically generating a recommendation list for a target user based on available side information that is pertinent to the target user but extrinsic to the recommended commodities. A set of training users and their side information of a plurality of attributes are correlated by using a first correlation. The set of training users and a plurality of commodities that have been purchased by the training users are correlated by using a second correlation. Thus, a third correlation derived from the first and the second correlations correlate the plurality of attributes and the plurality of commodities. The first and second correlations may be represented by respective matrices that are constructed based on user data collected over the Internet (or training data). The third correlation may be derived by combining (e.g., multiplying) the two matrices that represent the first and the second correlations.

The third correlation is then applied on the target user's side information to yield a rank of the plurality of commodities. Thereby, a list of commodities can be automatically selected from the plurality of commodities and recommended to the target user. As a recommendation list can be yielded based on only a target user's side information that is usually readily available, the present disclosure can be utilized to generate a recommendation list despite cold start issues. Further, since the correlations are constructed based on empirical data collected in real life, the recommendation list can estimate the purchase tendency of a target user with high marketing efficiency.

According to one embodiment of the present disclosure, a computer implemented method of automatically generating a recommendation list of commodities to a target user comprises: (1) accessing a first correlation that correlates a plurality of training users and a plurality of attributes pertinent thereto; (2) accessing a second correlation that correlates said plurality of training users and a plurality of commodities; (3) accessing information on said plurality of attributes with respect to said target user; and (4) determining said recommendation list of commodities for said target user based on said first correlation, said second correlation and said information, wherein said recommendation list of commodities are selected from said plurality of commodities.

A third correlation may be derived from said first correlation and said second correlation and correlate said plurality of attributes and said plurality of commodities. The first correlation, said second correlation and said third correlation are represented by respective mathematical formulas.

In one embodiment, the method further comprises: constructing a first matrix representing the first correlation and constructing a second matrix representing the second correlation; and deriving a third matrix representing the third correlation. The third matrix may be derived by combining the first matrix and the second matrix using a logarithm norm operator. The method may further comprise assigning respective weight factors to the plurality of attributes. The plurality of attributes may have no inherent correlation with the plurality of commodities.

In another embodiment of the present disclosure, a non-transitory computer-readable storage medium embodying instructions that, when executed by a processing device of a website, cause the processing device to perform a method of creating a recommendation list of books for a target user. The method comprises: (1) accessing a first statistical correlation that correlates a plurality of training users and a plurality of attributes pertinent thereto; (2) accessing a second statistical correlation that correlates the plurality of training users and a plurality of books, wherein the plurality of attributes have no intrinsic correlation with the plurality of books; (3) accessing information on the plurality of attributes with respect to the target user, wherein the target user has no purchase record on the plurality of books with the website; (4) determining the recommendation list of books for the target user based on the first statistical correlation, the second statistical correlation and the information, wherein the recommendation list of books are selected from the plurality of books; and (5) during a recommendation event, presenting the recommendation list to the target user through a recommendation channel.

In another embodiment of the present disclosure, a website associated system comprises: a processor; and a memory coupled to the processor and comprising instructions that, when executed by the processor, cause the processor to perform a method of determining recommendations of commodities to a target user that is substantially unfamiliar to the website. The method comprises: (1) accessing a first correlation that correlates a plurality of training users and a plurality of attributes pertinent thereto; (2) accessing a second correlation that correlates the plurality of training users and a plurality of commodities; (3) accessing information on the plurality of attributes with respect to the target user; and (4) determining the recommendation list of commodities for the target user based on the first correlation, the second correlation and the information, wherein the recommendation list of commodities are selected from the plurality of commodities.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a flow chart depicting an exemplary computer implemented method of determining a customized list of recommended commodities to a target user based on side information thereof and a statistical correlation in accordance with an embodiment of the present disclosure.

FIG. 2 illustrates an exemplary computer implemented process of automatically determining customized recommendations for multiple target users with a cold start in accordance with an embodiment of the present disclosure.

FIG. 3 illustrates a sample matrix operation process of automatically determining customized recommendations for a new user with a cold start in accordance with an embodiment of the present disclosure.

FIG. 4 is a diagram illustrating an exemplary on-screen graphic user interface (GUI) that presents a customized recommendation list automatically generated based on side information in accordance with an embodiment of the present disclosure.

FIG. 5 is a block diagram illustrating an exemplary computing system including an automatic recommendation list generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Generating Recommendations for Unfamiliar Users by Utilizing Social Side Information

In many situations, despite the lack of information that directly relates a new user to the products to be marketed (e.g., the purchase history), side information of the new user is available. Page-likes indicated in a user's social network account provide an exceptionally strong signal for cold start recommendation. For example, if the user logs into an on-line ecommerce site using his or her Facebook credentials and grants access to limited profile information, such information can be leveraged to generate initial set of recommendations that are tailored to that specific user in accordance with an embodiment of the present disclosure.

Overall, provided herein are system and method for identifying commodities for recommendation to a target user based on side information that is pertinent to a specific target user and extrinsic to the commodities. A computer implemented method according to the present disclosure employs training data to derive a statistical correlation between users' side information of a plurality of attributes with a plurality of commodities. The training data includes side information of a set of training users and a plurality of commodities towards which the training users have manifested preference. Based on the derived statistical correlation and the target user's side information, a probability distribution can be determined representing the target user's tendency to purchase the plurality of commodities. As a result, a list of commodities can be automatically selected from the plurality of commodities and recommended to the target user.

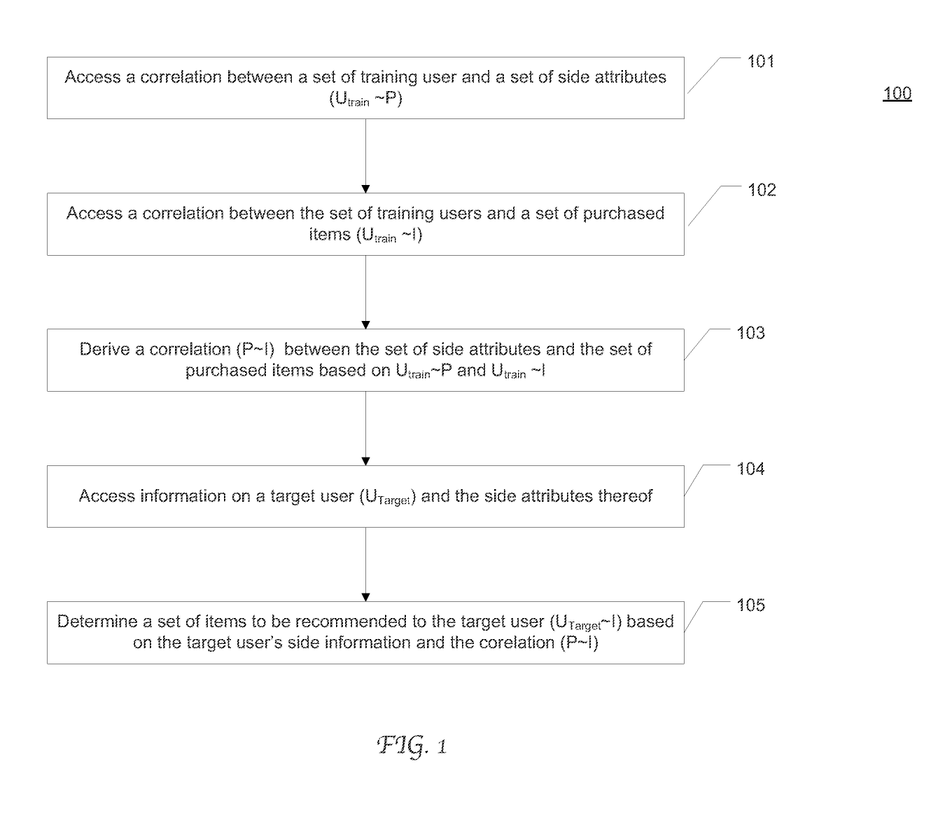

FIG. 1 is a flow chart depicting an exemplary computer implemented method 100 of determining a customized list of recommended commodities to a target user based on side information thereof and a statistical correlation in accordance with an embodiment of the present disclosure. In one embodiment, the target user may be unfamiliar to the website and thus have a cold start, e.g., has no prior purchase history with the website. Method 100 can be implemented on a server hosted by, for example, a shopping website that sells a plurality of commodities. The side information and shopping behaviors of the users are used as the training data to derive a statistical correlation between user side information and the plurality of commodities.

The present disclosure is not limited to any type of commodities for recommendation. The plurality of commodities referred herein may include tangible or intangible goods as well as services, such as books, movies, music, clothes, furniture, food, toys, electronic devices, appliances, health products, event tickets, lessons, job positions, travel packages, etc., and combinations thereof.

The present disclosure is not limited to any manner, criteria or process of selecting the training data. The training data may be related to all users or a select set of users with purchase records and side information accessible to the server. Further, the plurality of commodities can include items that have been purchased, viewed in extended time, marked as favorite, highly rated, and/or added to wish list by one or more of the training users.

As illustrated, at 101, a correlation between a set of training users and a set of side attributes are accessed. The correlation can be expressed as U_{Train}˜P, wherein U_{Train} represents the set of training users and P represents the set of side attributes. In some embodiments, the correlation U_{Train}˜P is mathematically represented by a matrix with each element corresponding to a trait of a specific side attribute with respect to an individual training user, as to be described in greater detail below. In some other embodiments, the correlation U_{Train}˜P can be represented in a mathematical formula or model that is derived theoretically, empirically, or semi-empirically, e.g., through a training process.

The side information referred herein may be related to any suitable side attribute that tends to characterize a user. The side attributes may or may not have intrinsic or inherent correlation with the plurality of commodities that potentially can be recommended to a target user, e.g., a new user. For example, the side information can include user demographic information, e.g., age, gender, location, ethnicity, occupation, marital status, habits, religion, physical attributes, and educations. The side information may also include social network information that is collected from the user accounts with one or more social media networks. For example, the social network information may pertain to specific Facebook groups, page-likes shared in Facebook, associations, visited webpages, visited places, other experiences, and etc.

At 102, a correlation between the set of training users and a set of commodity items that have even been purchased by one or more of the set of training users are accessed. The correlation can be mathematically expressed as U_{Train}˜I, wherein U_{Train} represents a set of training users, and I represents set of the set of items. In some embodiments, the correlation U_{Train}˜I is mathematically represented by a matrix with each element corresponding to a purchase event of a specific commodity respect to an individual training user, as to be described in greater detail below. In some other embodiments, the correlation U_{Train}˜I can be represented in a mathematical formula or model that is derived empirically, theoretically or semi-empirically.

At 103, based on the correlations (U_{Train}˜P and U_{Train}˜I, a correlation that correlates the side attributes P with the items I can be derived, representable as P˜I. In some embodiments, the correlation (P˜I) is mathematically represented by a matrix with each element corresponding to relatedness between a specific side attribute and a specific commodity, as to be described in greater detail below. In some other embodiments, a mathematical formula or model representing P˜I can be derived from the mathematical formulas or matrices representing U_{Train}˜P and U_{Train}˜I.

At 104, a target user's U_{Target} information on the side attributes P is accessed. In some embodiments, the target user's information can be represented in a form of a vector, wherein each element corresponds to a trait of a specific side attribute of the target user. At 105, based on the target user's information and the derived correlation P˜I, a rank of the plurality of items is yielded. The rank can be computed by applying the correlation P˜I on the vector representing the target user side information. The rank indicates estimated purchase tendency or preference over that the plurality of items (I) for the target user, e.g., from the most- to the least-recommended times. Thereby a set of items can be selected from the plurality of items (I) and then recommended to the target user.

As a recommendation list can be yielded based on only a target user's side information that is usually readily available, the present disclosure can be utilized to generate a recommendation list that is customized to the user's specific profile despite the cold start issues. Further, since the correlation between user profiles and the commodities are constructed empirically based on training data collected in real life, the recommendation list can advantageously estimate the purchase tendency of a target user with a high marketing efficiency.

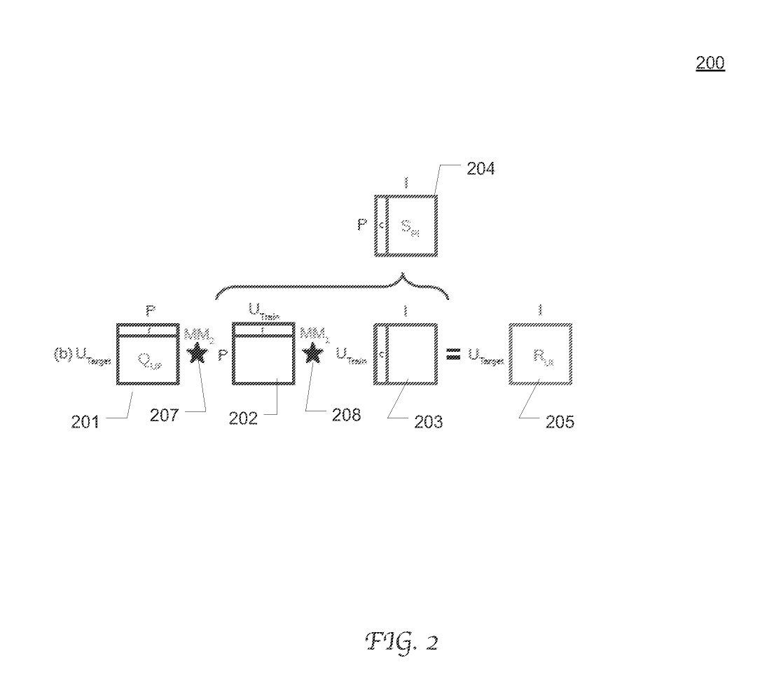

FIG. 2 illustrates a diagram 200 of databases used in an exemplary computer implemented process of automatically determining customized recommendations for multiple target users with a cold start in accordance with an embodiment of the present disclosure. The process 200 is illustrated in a mathematical framework of item-based collaborative filtering using side information. The framework involving multiplication of three matrices 201, 202, and 203 which yields a fourth matrix 205.

In this example, U_{Target}={u₁, u₂, . . . , uₘ} represents the set of target users. Uₜᵣₐᵢₙ={u′₁, u′₂, . . . , u′_{m′}} represents the set of training users, for example who have made purchases on at least one of the target items and have side information available. I=={i₁, i₂, . . . , iₙ} represents the set of target items. Under cold start conditions, no data directly linking U_{Target} and the target items is available. In other words, the target users U_{Target} are unfamiliar to the website, e.g., does not have any prior purchase history stored by the website. P=={p₁, p₂, . . . , pₗ} represents a set of attributes for users, such as specific demographic traits, specific Facebook friends, or specific Facebook page-likes, etc.

The matrices 201 and 202 have dimensions over P. Thus for Q_{UP} 201 and any pεP (e.g., page-likes) and uεU_{Target}, Q_{UP}=1 if u had attribute p (e.g., u liked p); and Q_{UP}=0 if otherwise. Defining the matrix 202 analogously, the operator MM1 208 is applied to obtain a matrix S_{Pl} 204 which relates personal attributes P to preferences over items I. Finally, Q_{UP}(MM2)S_{Pl} yields recommendation matrix R_{Ul} 205.

Various attributes of side information have different impact in terms of determining a recommendation list and thus can be treated with different weights. For instant, page-likes information provides much stronger signal for a cold start recommendation than demographics information. The weight distribution over the side attributes can be manually assigned or automatically generated based on an empirical data or model. For example, the resultant R_{Ul} 205 can further be multiplied with a weight vector wherein each element corresponds to a weight factor assigned to a specific attribute.

For a set of training users U_{Train} (potentially overlapping with U_{Target}) and analogous definitions of the remaining matrices on the left hand side of equality in FIG. 2, the operator denoted by MM1 (e.g., matrix multiplication) is applied to obtain Sₗₗ, where for items tεI and fεI, Sᵢⱼ represents an item-item similarity between I and J. Finally, applying operator MM2 to compute yields Q_{Ul}(MM2)Sₗₗ a recommendation matrix R_{Ul}. For each target user iεU_{Target} and item tεl, Rᵤₜ represents a real valued rating. Given Rᵤₜ and sorting items in descending order for each u yields a ranked list of most- to least-recommended items for user u.

The operators MM1 and MM2 in FIG. 2 represent generalized matrix multiplications and permit any similarity metric over two vectors as well as the standard inner product. The operators MM1 and MM2 can be in any of the various suitable forms. For example, in order to receive a version of item-based collaborative filtering, cosine similarity can be used in place of the inner product for MM1.

In general, a similarity matrix Stm [symbol] r,c [symbol] for the row r and column c vectors in a matrix can be used to define the operators MM1 and MM2 which need not be same.

In some embodiments, Stm [symbol] r,c [symbol] can be given by standard matrix multiply inner product, representable as

Stm [symbol] r,c [symbol] = [symbol] r,c [symbol] .

In some embodiments, for τε [symbol] , Stm [symbol] r,c [symbol] can be given by a binary thresholded version of the inner product, representable as

$$Sim 〈 r , c 〉 = \{ \begin{matrix}1 & if 〈 r , c 〉 > τ \\ 0 & otherwise\end{matrix} .$$

In some embodiments, Stm [symbol] r,c [symbol] can be given by a logarithm norm of the inner product, representable as

Stm [symbol] r,c [symbol] =log [symbol] r,c [symbol] .

In some embodiments, Stm [symbol] r,c [symbol] fan be cosine similarity and obtained by an inner product of two L₂ normalized vectors, e.g.,

$$Sim 〈 r , c 〉 = \frac{〈 r , c 〉}{‖ r ‖ ‖ c ‖} .$$

Other possible similarity metrics may also be used for purpose of practicing the present disclosure, e.g. Pearson Correlation Coefficient and Jaccard in the special case of binary vectors. The various similarity metrics can be implemented in any method or process that is well known in the art.

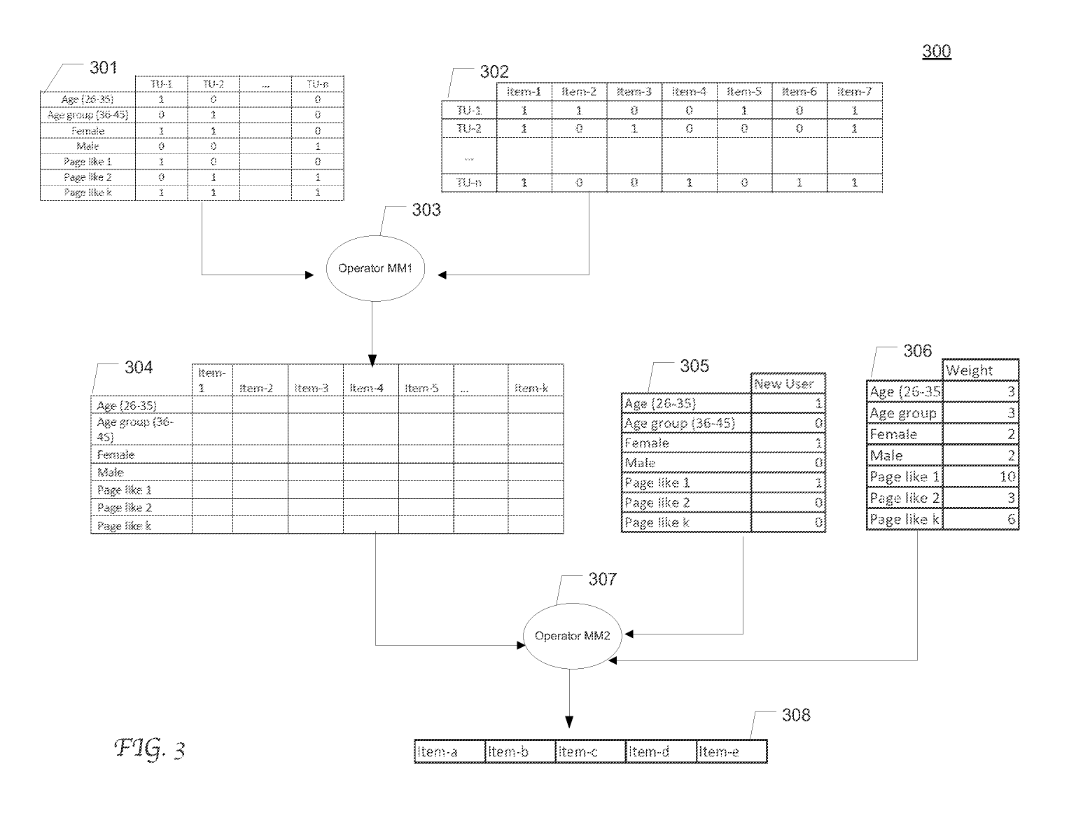

FIG. 3 illustrates a sample matrix operation process 300 of automatically determining customized recommendations for a new user with a cold start in accordance with an embodiment of the present disclosure. The matrix operation process 300 is based on the framework illustrated in FIG. 2 and may be computer generated and/or implemented.

The matrix 301 (U_{Train}˜P) correlates training users (TU-1, TU-2, . . . , TU-n) and the side attributes including 2 age groups (26-35 and 36-45), 2 gender groups (female and male), and 3 page-likes (1, 2, and k). Each element in matrix 301 reflects the trait of each training user with respect to a specific attribute. A value “1” for instance denotes the training user has the trait of the specific attribute, while value “0” denotes otherwise.

The matrix 302 (U_{Train}˜I) correlates training users (TU-1, TU-2, . . . , TU-n) and 7 commodity items (items 1-7). Each element in matrix 302 reflects an individual training user's preference (e.g., purchase event) over a specific item. A value “1” denotes the training user has manifested preference over the specific item, while value “0” denotes otherwise.

The two matrices 301 and 301 are multiplied by using the multiplication operator MM1 330 and yields a matrix 304. In some other embodiments, the two matrices may be combined using other suitable operators. The matrix 304 correlates the side attributes with the 7 items, wherein each element (value not shown) represents the relatedness between a specific attribute and a specific item. The vector 305 represents the new user's traits of the 7 side attributes. The vector 306 represents a weight distribution over the side attributes. The matrix 304, and vectors 305 and 306 (or a transpose thereof) are combined, e.g., multiplied, by using the operator MM2 and yields a vector of 7 elements (not shown), wherein each element is regarded as a rank score of a specific item for recommendation.

Then the top 5 items 305 are selected based on the rank scores and recommended to the new user in a recommendation event. Recommendation lists generated in accordance with the present disclosure can be presented to a user through various recommendation channels, such as emails, on-line shopping websites, pop-up advertisements, electronic billboards, newspapers, electronic newspapers, magazines, and etc. The foregoing process can be repeated for each target user. Also, in response to a new side attribute (e.g., a new page-like) and new training user (e.g., a new user converts to a training user after purchasing an item), the foregoing process 201-204 can be repeated. It will be appreciated that construction and updating of the matrices and vectors 301, 302, 305 and 306 can be performed automatically under computer control or manually in any suitable method that is well known in the art.

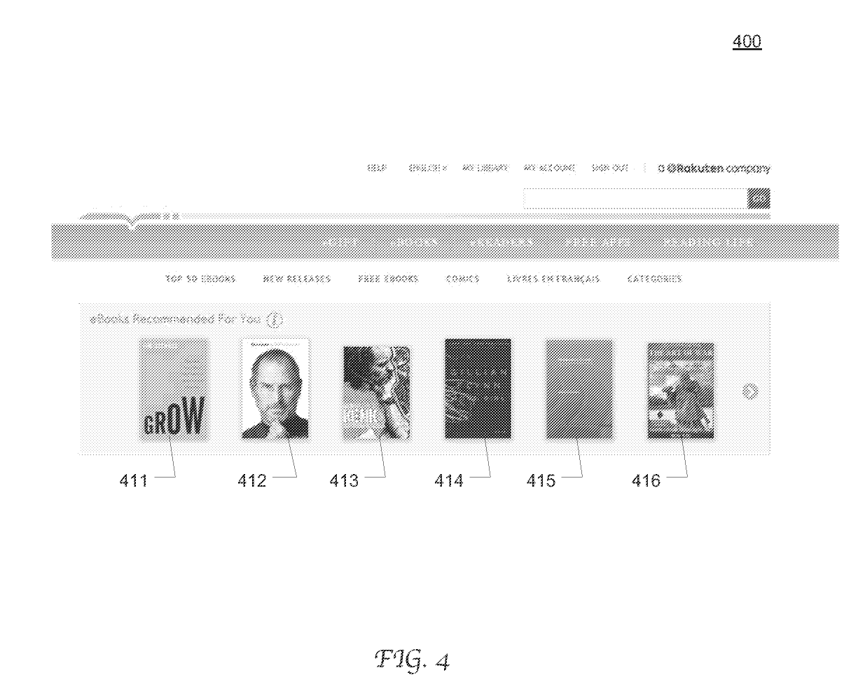

FIG. 4 is a diagram illustrating an exemplary on-screen graphic user interface (GUI) 400 that presents a recommendation list (with books 411-416) automatically generated based on side information of a target user in accordance with an embodiment of the present disclosure. The present recommendation list may encompass only a portion of the recommendation items resultant from a process shown in FIG. 2. In a different recommendation instance, such as the user's next visit of the on-line store, a different recommendation list may be presented. In some embodiments, the recommended books in a list may be arranged in a pattern on the GUI and the pattern may reflect the importance of the categories to the user. However, in some other embodiments, the books can be arranged randomly to present one or more diversified views to the user.

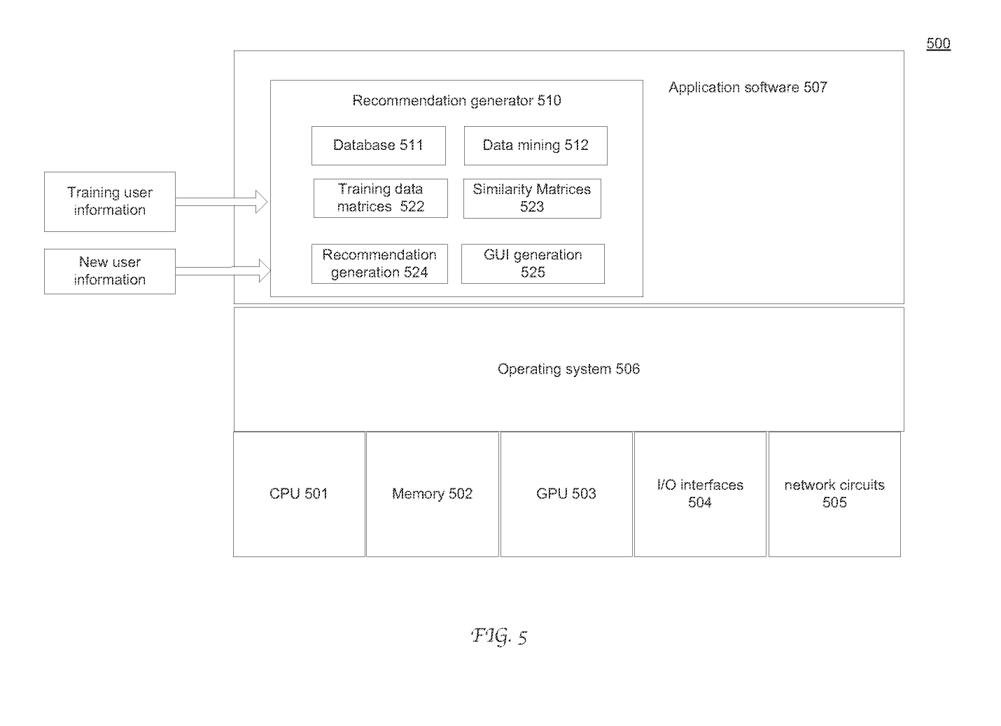

FIG. 5 is a block diagram illustrating an exemplary computing system 500 including an automatic recommendation list generator 510 in accordance with an embodiment of the present disclosure. The computing system comprises a processor 501, a system memory 502, a GPU 503, I/O interfaces 504 and network circuits 505, an operating system 506 and application software 507 including the automatic recommendation list generator 510 stored in the memory 502. When incorporating programming configuration and user information collected through the Internet, and executed by the CPU 601, the automatic recommendation list generator 510 can produce recommendations in accordance with an embodiment of the present disclosure.

The recommendation generator 510 may perform various functions and processes as discussed with reference to FIG. 1-4. The automatic recommendation list generator 510 encompasses a database 511, a data mining module 512, a training data matrix construction module 522, a similarity matrix generation module 523, a recommendation generation module 524, and a GUI generation module 525.

The database 511 includes all the information regarding each affiliated user, wherein each user is has a user account registered with the server. The data mining module 512 can operate to discover relevant training data and new user data from the database 511, such as demographic information, side information, and purchase behaviors, as described in greater detail above.

The training data matrix construction module 522 can construct the matrices representing U_{Train}˜I and U_{Train}˜P and update them with new training data. A similarity matrix generation module 523 can generate the similarity matrix representing P˜I, e.g., by matrix multiplication operations. The recommendation generation module 524 can multiply the similarity matrix on target user information and thereby generate a customized recommendation list. The GUI generation module 525 can render an on-screen GUI to present recommendation list, e.g., when the target user visits the website, as shown in FIG. 4.

As will be appreciated by those with ordinary skill in the art, the automatic recommendation generator 610 may include any other suitable components and can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of automatically generating a recommendation list of commodities to a target user, said method comprising:
accessing a first correlation that correlates a plurality of training users and a plurality of attributes pertinent thereto;
accessing a second correlation that correlates said plurality of training users and a plurality of commodities;
accessing information on said plurality of attributes with respect to said target user; and
determining said recommendation list of commodities for said target user based on said first correlation, said second correlation and said information, wherein said recommendation list of commodities are selected from said plurality of commodities.

2. The computer implemented method of claim 1, wherein said determining comprises deriving a third correlation from said first correlation and said second correlation, and wherein said third correlation correlates said plurality of attributes and said plurality of commodities,

3. The computer implemented method of claim 2, wherein said first correlation, said second correlation and said third correlation are represented by respective mathematical formulas.

4. The computer implemented method of claim 2 further comprising:
constructing a first matrix representing said first correlation;
constructing a second matrix representing said second correlation; and
deriving a third matrix representing said third correlation.

5. The computer implemented method of claim 4, wherein said deriving comprises multiplying said first matrix and said second matrix by a logarithm norm operator.

6. The computer implemented method of claim 1 further comprising assigning respective weight factors to said plurality of attributes, and wherein said determining comprises determining said recommendation list of commodities further based on said respective weight factors.

7. The computer implemented method of claim 1, wherein said determining is performed by a shopping website and wherein said plurality of commodities correspond to commodities that said plurality of training users have purchased, and wherein said target user has no previous purchase record at said shopping website with respect to said plurality of commodities.

8. The computer implemented method of claim 1, wherein said plurality of attributes have no inherent correlation with said plurality of commodities, and wherein said plurality of attributes are selected from demographic attributes of said plurality of training users, popular subject matters among said plurality of training users, associations that said plurality of training users are affiliated with, webpages that have been visited by said plurality of training users, and places that said plurality of training users visited.

9. The computer implemented method of claim 1, wherein said plurality of commodities comprise commodities selected from a group consisting of books, clothes, furniture, food, toys, electronic devices, appliances, health products, services, tickets and combinations thereof.

10. A non-transitory computer-readable storage medium embodying instructions that, when executed by a processing device of a website, cause the processing device to perform a method of creating a recommendation list of books for a target user, said method comprises:
accessing a first statistical correlation that correlates a plurality of training users and a plurality of attributes pertinent thereto;
accessing a second statistical correlation that correlates said plurality of training users and a plurality of books, wherein said plurality of attributes have no intrinsic correlation with said plurality of books;
accessing information on said plurality of attributes with respect to said target user, wherein said target user has no purchase record on said plurality of books with said website;
determining said recommendation list of books for said target user based on said first statistical correlation, said second statistical correlation and said information, wherein said recommendation list of books are selected from said plurality of books; and
during a recommendation event, presenting said recommendation list to said target user through a recommendation channel.

11. The non-transitory computer-readable storage medium of claim 9 further comprising determining respective weight factors for said plurality of attributes, and wherein said recommendation list is determined further based on said respective weight factors.

12. The non-transitory computer-readable storage medium of claim 11, wherein said determining comprises deriving a similarity correlation that correlates said plurality of attributes and said plurality of books, and wherein said deriving said similarity correlation comprises deriving from said first statistical correlation and said second statistical correlation.

14. The non-transitory computer-readable storage medium of claim 12, wherein first statistical correlation and said second statistical correlation are represented by respective matrices, and wherein said deriving said similarity correlation comprises combining said respective matrices.

15. The non-transitory computer-readable storage medium of claim 11, wherein said presenting a recommendation list comprises rendering a graphic user interface (GUI) configured to display said recommendation list to said target user in accordance with a predetermined order.

16. A website associated system comprising:
a processor,
a memory coupled to said processor and comprising instructions that, when executed by said processor, cause the processor to perform a method of determining recommendations of commodities to a target user that is substantially unfamiliar to said website, said method comprising:
accessing a first correlation that correlates a plurality of training users and a plurality of attributes pertinent thereto;
accessing a second correlation that correlates said plurality of training users and a plurality of commodities;
accessing information on said plurality of attributes with respect to said target user; and
determining said recommendation list of commodities for said target user based on said first correlation, said second correlation and said information, wherein said recommendation list of commodities are selected from said plurality of commodities.

17. The system of claim 16 further comprising deriving a third correlation from said first correlation and said second correlation, and wherein said third correlation correlates said plurality of attributes and said plurality of commodities,

18. The system of claim 17 further comprising:
generating a first matrix representing said first correlation;
generating a second matrix representing said second correlation; and
deriving a third matrix through mathematical operations, wherein said third matrix representing said third correlation.

19. The system of claim 16 further comprising assigning respective weight factors to said plurality of attributes, and wherein said determining comprises determining said recommendation list of commodities further based on said respective weight factors.

20. The system of claim 16, wherein said plurality of commodities correspond to commodities that said plurality of training users have purchased, wherein said plurality of attributes have no inherent correlation with said plurality of commodities and wherein said target user has no previous purchase record with respect to said plurality of commodities.
